(19) United States
(12) Patent Application Publication
(10) Pub. No.: US 2012/0148274 A1
(43) Pub. Date: Jun. 14, 2012

(54) PROVIDING DESIRED GLOSS TO MIXED MEDIA SHEETS

(76) Inventors: Jerry A. Pickering, Hilton, NY (US); James H. Hurst, Rochester, NY (US)

(21) Appl. No.: 12/963,680

(22) Filed: Dec. 9, 2010

(51) Int. Cl. G03G 15/20

(52) U.S. Cl. 399/45

(57) ABSTRACT

Method of fixing marking particles to sheets having different basis weights in a continuous stream of receiver sheets, includes: providing two fixing members which engage each other to form a nip, at least one of the members being heated; and adjusting at least one parameter including temperature, speed, or pressure in the fixing nip, which will provide a predetermined gloss upon the sheet(s). The method further includes feeding the sheets of the higher basis weight through the nip so that the higher basis weight sheet(s) is fed more times through the nip than the other sheet(s); and applying marking particles to the prepared heavier basis weight sheets and passing them through the nip so that the gloss formed by the marking particles is substantially the same for heavier basis weight sheets as for lighter basis weight sheets.

### FIELD OF THE INVENTION

This invention relates to maintaining a consistent image gloss when continuously printing on receivers of mixed basis weights.

### BACKGROUND OF THE INVENTION

In typical commercial electrostatographic reproduction apparatus (copier/duplicators, printers, or the like), a latent image charge pattern is formed on a uniformly charged charge-retentive or photo-conductive member having dielectric characteristics (hereinafter referred to as the dielectric support member). Pigmented marking particles are attracted to the latent image charge pattern to develop such image on the dielectric support member. The developed image is transferred to a receiver member, such as a sheet of paper, transparency or other medium, in an electric field. After transfer, the receiver member bearing the transferred image is transported away from the dielectric support member, and the image is fixed (fused) to the receiver member by heat and pressure to form a permanent reproduction thereon.

Some reproduction apparatus have been designed to produce multi-color copies. In such reproduction apparatus, multiple color separation images are respectively developed with complementary colored marking particles, and then transferred in superposition to a receiver member. Fixing of multi-color marking particle images to a receiver member requires substantially different operating parameters than fixing standard black marking particle images to a receiver member. Moreover, the respective operating parameters can in fact be in contradistinction. That is, multi-color images require a high degree of glossiness for a full, rich depth of color reproduction; on the other hand, since glossiness for black marking particle images can significantly impair legibility, a matte finish is preferred.

Additionally, in the multi-color copy market, many different types of receiver members are used. The receiver members vary in surface finish gloss, weight, and thickness. Since the market demands a high quality appearance for finished copies, the image gloss should match the gloss of the selected receiver member. The reproduction apparatus is used to print receivers that will be collected and bound together as a book. In such a book, it is common for the cover and some insert sheets to be made of receivers that are of a different basis weight (typically measured in grams per square meter, or gsm) than the sheets that make up the body of the book. It is convenient for the receiver sheets in the book to be printed in one pass through the printing apparatus, instead of sheets of different weight separately prior to collating them into the finished book. When a reproduction apparatus is used to print on multiple types or weights of receiver sheets in a single print job, this is referred to as printing with mixed media.

It is known that the glossiness of a marking particle image is, at least in part, dependent upon the marking particle melting characteristics in the fixing process and the characteristics of the receiver members. In general, the fixing apparatus serves to soften or at least partially melt the marking particles, enabling the marking particles to permeate into the fibers of the receiver member so that the marking particles are fixed to the receiver member. For example, the fixing apparatus can include a heated roller which contacts the marking particles and the receiver member under pressure.

It is also known that the glossiness of the marking particle image is, at least in part, dependent on the basis weight of the receiver sheets. The fixing apparatus delivers heat to the marking particles in order to fix the particles to the sheet and to soften the particles sufficiently for them to change their shape and form a glossy surface. Heat from the fixing apparatus that is absorbed by the receiver sheet is no longer available to transform the marking particles and, in general, receiver sheets of higher basis weight have greater capacity to absorb heat. Therefore, receiver sheets of higher basis weight typically require more heat from the fixing apparatus to attain a given level of image glossiness.

In a fixing apparatus that uses heated members, such as rollers or belts, to contact the receiver sheet there are typically three parameters that are used to regulate the amount of heat that is delivered by the fixing members to the receiver sheets. First, speed of the receiver sheets through the nip between the fixing members is regulated. When the speed is slower, the receiver sheets are in the nip for a longer time, permitting more heat to flow from the fixing members to the receiver sheet. Second, the temperature of the fixing members is regulated. When the fixing member is at a higher temperature, more heat will flow to the receiver sheet. Third, the force in the nip between the fixing members is regulated. Higher pressure in the nip forces more intimate contact between the fixing member and the receiver sheet, permitting higher heat transfer. Also, the higher pressure causes the fixing members to deflect so that the nip between the fixing members is wider. The wider nip causes the receiver sheet to be in contact with the fixing members for a longer time, permitting more heat to flow from the fixing members to the receiver sheet. U.S. Pat. No. 5,956,543 describes a fixing apparatus wherein speed, temperature, and pressure are controlled according to the type and basis weight of the receiver sheets to obtain a desired gloss level on multiple receiver types.

The three methods of regulating the amount of heat that is delivered by a fixing apparatus to a receiver sheet have drawbacks that can make the use of these methods inconvenient or uneconomical. For example, it is uneconomical or impractical to design an imaging system that can operate at multiple speeds. It can also take an excessive amount of time to change the temperature of the fixing members, so that using a temperature change to regulate the heat delivery can cause an unacceptable loss of productivity for the reproductive apparatus. The mechanism for changing the force in the nip between the fixing members is prohibitively expensive. These limitations can cause the designers of the reproductive apparatus to provide another way of varying the heat that is delivered to the receiver sheet by the fixing apparatus.

When it is desired to have marking particle images on both sides of the receiver sheet, the typical reproduction apparatus will form and fix an image on one side of the sheet then transfer the sheet to a duplex path that will return the sheet to the point where it receives the marking particle image, but this time with the opposite side of the receiver sheet presented to receive the image. It is known that a fixing apparatus that fixes marking particle images on one side of the sheet at a time will often produce a higher gloss level on the image that has passed twice through the fixing apparatus. U.S. Pat. No. 5,581,339 describes a method of coping with the tendency for the fixing apparatus to give a higher gloss on the image that has passed twice through the fixing apparatus. U.S. Pat. No. 6,078,760 describes a fixing apparatus that uses multiple passes of the receiver sheet through the fixing apparatus to obtain the desired level of gloss on the image.

### SUMMARY OF THE INVENTION

A method of fixing marking particles to sheets in a continuous stream of receiver sheets wherein some sheets have a lighter basis weight and at least one sheet has a heavier basis weight, comprising:

a) providing two fixing members which engage each other to form a nip, at least one of the members being heated;

b) adjusting at least one parameter including temperature applied to a sheet as it passes through the nip, or speed of the sheet as it passes through the nip, or pressure in the fixing nip applied to the sheet, which will provide a predetermined gloss upon the sheet(s) after they have passed through the nip;

c) feeding the sheets of the higher basis weight media through the nip before marking particles are formed on them so that the higher basis weight sheet(s) is fed more times through the nip than the other sheet(s) and these sheets are heated in preparation for receiving marking particles; and

d) applying marking particles to the prepared heavier basis weight sheets and passing them through the nip so that the gloss formed by the marking particles is substantially the same for the heavier basis weight sheets as for the lighter basis weight sheets.

In one effective embodiment of the invention, a controller of the reproduction apparatus can set the parameters of the fixing apparatus to provide the desired fixing level and gloss level of the image on the lightest basis weight receiver sheets in one pass through the fixing apparatus. If it then becomes necessary to create an image on a receiver sheet with a heavier basis weight, such as for a book cover or for an insert sheet, rather than change the parameters of the fixing apparatus, the controller will pass the heavier receiver sheet multiple times through the fixing apparatus using the duplex path of the reproduction apparatus to return the sheet to the entrance of the fixing apparatus before the marking particle image is transferred to the receiver sheet. These multiple passes through the fixing apparatus will change the temperature and moisture content of the receiver sheet so that when it finally passes through the fixing apparatus bearing an image, the image will attain the desired fixing level and gloss level in one pass through the fixing apparatus.

A feature of the present invention is that it avoids the negative consequences of the other ways of regulating the heat delivered to the receiver sheets, the cost of mechanisms to permit for multiple speeds in the reproduction apparatus or for multiple nip force levels in the fixing apparatus, or the loss of productivity while waiting for a change in the temperature of the fixing members, or damage to the image in the return path.

### BRIEF DESCRIPTION OF THE DRAWINGS

FIG. 1 is a schematic side view diagram of a electrophotographic printer adapted to provide the method of the present invention by having electrophotographic stations and a duplex media path; and

FIG. 2 is a block diagram of the logic that is used by the control unit for the electrophotographic printer shown in FIG. 1 to set the fixing parameters and the receiver motion which will provide a predetermined gloss upon mixed media sheets.

### DETAILED DESCRIPTION OF THE INVENTION

The response of a receiver sheet during the second pass through a fixing apparatus is different than during the first pass because the nature of the receiver sheet has been changed by the first pass. First, the receiver sheet will begin the second pass through the fixing apparatus at a higher temperature than the first pass because of the heat that was delivered to the sheet during the first pass. Second, if the receiver sheet is made of a hygroscopic material such as paper, the first pass through the fixing apparatus will drive moisture out of the receiver sheet so that on the second pass through the fixing apparatus, the heat capacity of the sheet will be less because of the reduced moisture content. For both reasons fixing the image on the second pass through the fixing apparatus will require less heat than did the fixing of the image on the first pass through the fixing apparatus. For high quality images, particularly photo-quality images, it is undesirable to pass the printed image through the duplex path as there is increased risk that the image will become damaged by the nip rollers or areas where the receiver undergoes a sharp change in direction as is common in compact printing devices. Additionally, for single sided printing such as book covers, it is further desirable that the receiver is heated and returned without additional structure to maintain the image side facing the fixing member as this lowers overall cost. The book covers are made of a higher basis weight sheet than are the body sheets of a book.

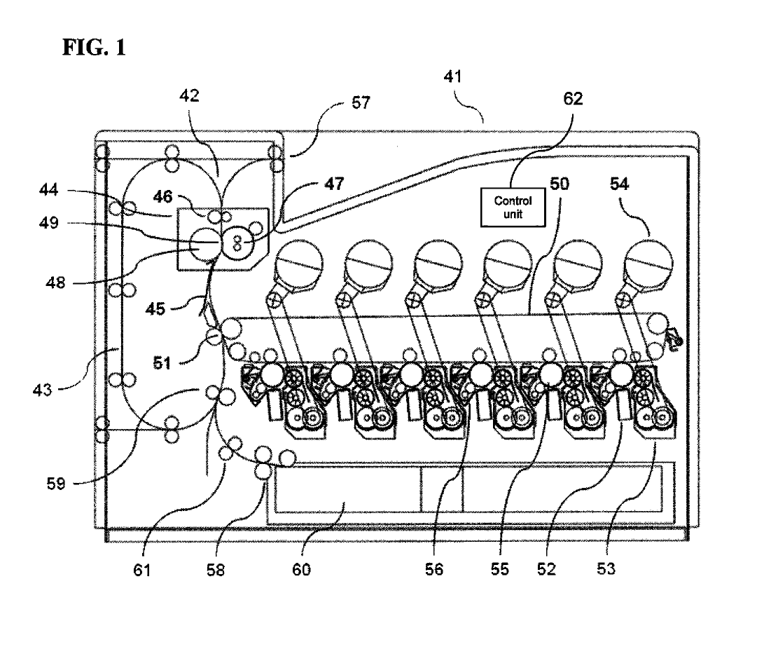

Referring to FIG. 1, a reproduction apparatus 41 includes multiple imaging stations each with a different color of marking particle. In each imaging station an image writer 52 creates an electrostatic image on the charged surface of a photoconductive member 55. A development station 53 applies pigmented marking particles from a marking particle storage and dispensing station 54 to create an image on the surface of the photoconductive member 55. The image is then electrostatically transferred to an image accumulation belt 50 and a photoconductor cleaning and charging station 56 prepares the surface of the photoconductive member 55 for another image. While the image is being formed on the image accumulation belt 50, a receiver is pulled from a receiver supply 60 by receiver feeding rollers 58 and transported by receiver transport rollers 61 to a receiver sheet positioning station 59. The multiple single color images combine on the image accumulation belt 50 to form a single multicolor image that is then electrostatically transferred to the receiver at an image transfer station 51. The receiver is then transported by way of a fixing apparatus entrance guide 45 to a fixing apparatus 44, where heat from fixing heaters 47 and pressure in a fixing nip 49 between fixing members 48 impart the desired fixing level and image gloss to the image. The receiver then passes through fixing apparatus exit rollers 46 and into a diverter 42 which can deliver the receiver to a receiver exit 57 or send the receiver back to the receiver sheet positioning station 59 by way of the duplex receiver path 43 so another image can be transferred to the other side of the receiver sheet or so the receiver can pass through the fixing apparatus 44 again prior to receiving an image. The duplex receiver path 43 includes a plurality of rollers and receiver guides for advancing the sheet along the duplex receiver path 43. When multiple sizes, types, and weights of receiver sheets are to receive images there will typically be multiple receiver supplies (not shown) located either below or to the left of the receiver supply that is shown. An electronic control unit 62 governs the operation of the reproduction apparatus. The control unit will be understood to include a processor and electronics necessary to provide control signals to various parts of the reproduction apparatus 41.

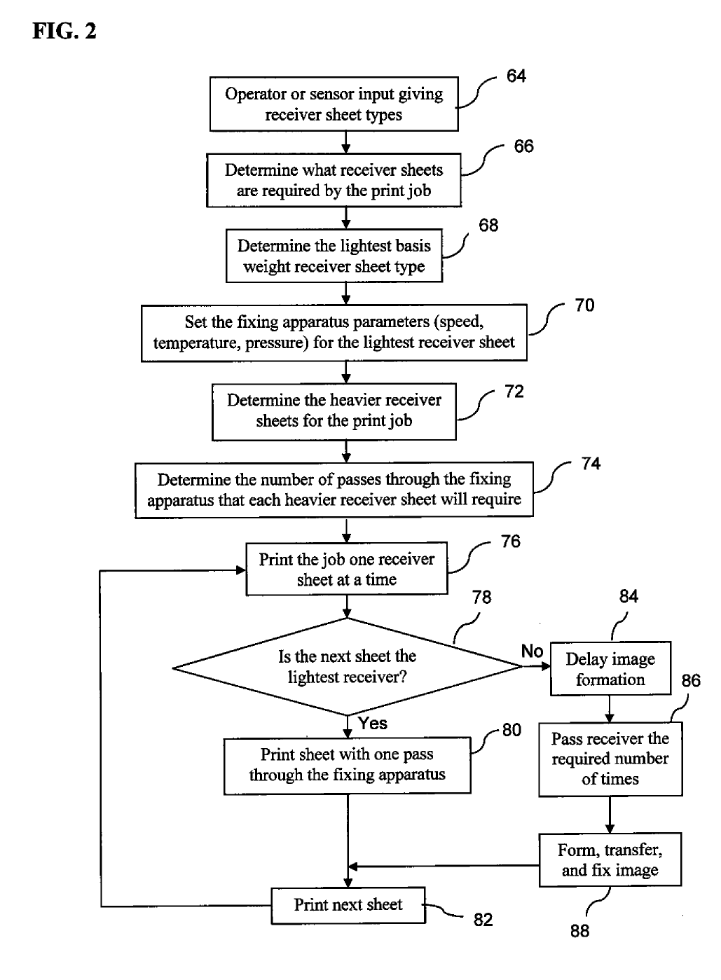

FIG. 2 is a block diagram of the logic that is used by the control unit 62 for the reproduction apparatus 41 shown in FIG. 1 to set the fixing parameters and the receiver sheet motion. The control unit 62 receives input from the operator or from receiver sensors in the receiver supplies (Block 64) about the sizes, types, and basis weights of the receiver sheets that are loaded into the receiver supplies 60. The control unit 62 also receives input from the operator as to the content of the image that is to be printed and the receivers that are desired. Block 66 shows that the control unit 62, using the operator input, determines the receiver sheets that are required by the print job. Block 68 shows that the control unit 62 determines from the operator input which receiver type is the lightest basis weight. Using selection criteria that have been set up in the control unit program and as shown in Block 70, the control unit 62 sets the receiver speed, the fixing member temperatures, and the fixing members' nip pressure so that the lightest basis weight receiver that will be used will attain the desired fixing level and image gloss on one pass through the fixing apparatus 44. Block 72 shows that the control unit 62 then determines what heavier basis weight receiver sheets will be included. Block 74 shows that the control unit 62 selects the number of passes through the fixing apparatus 44 that will properly condition the heavier basis weight receiver so that it will have the desired fixing level and image gloss when it finally receives an image.

The control unit 62 then operates the reproduction apparatus 41 with fixing parameters set at the selected levels (Block 76). Block 78 is a decision point for each receiver sheet in the print job in which the control unit 62 asks whether the next receiver sheet is the lightest basis weight receiver. If the answer is yes, Block 80 shows that the receiver sheets of the lightest basis weight are processed by conventional methods, with each receiver sheet passing through the image transfer station 51 and fixing apparatus 44 one time, or twice if the receiver sheet is to receive images on both sides. After Block 80 the control unit 62 will print the next sheet (Block 82). If the answer is no, Block 84 shows that the control unit 62 delays the formation of the image while the heavier basis weight receiver sheet, according to Block 86, is passed through the fixing apparatus 44 and the duplex receiver path 43 the number of times that the control unit 62 has determined is necessary. The control unit 62 also controls the heat applied to the sheets and the speed of the sheets as they pass through the nip. When the control unit 62 determines that the heavier basis weight receiver sheet has been sufficiently prepared, the control unit, according to Block 88, permits the image to be formed and transferred to the receiver sheet before the receiver sheet's final pass (or passes, if there is to be image on both sides) through the fixing apparatus 44. After Block 88 is completed the control unit 62 will print the next sheet (Block 82). This process repeats until all of the receiver sheets that are in the print job have been printed.

In the simplest embodiment of this invention, the control unit 62 determines the necessary number of passes of the receiver sheet through the fixing apparatus 44 based on rules that had been programmed into the logic of the control unit 62. In another embodiment of this invention, there would be placed electronic sensors in the duplex receiver path 43 to detect the temperature or the moisture content of the receiver sheet. The control unit 62 would then decide the necessary number of passes of the receiver sheet through the fixing apparatus 44 based on the receiver sheet's temperature and moisture content response to earlier passes through the fixing apparatus 44.

The invention has been described in detail with particular reference to certain preferred embodiments thereof, but it will be understood that variations and modifications can be effected within the spirit and scope of the invention

### PARTS LIST

41 reproduction apparatus
42 diverter
43 duplex receiver path
44 fixing apparatus
45 fixing apparatus entrance guide
46 fixing apparatus exit rollers
47 fixing heaters
48 fixing members
49 fixing nip
50 image accumulation belt
51 image transfer station
52 image writer
53 development station
54 dispensing station
55 photoconductive member
56 photoconductive cleaning and charging station
57 receiver exit
58 receiver feeding rollers
59 receiver sheet positioning station
60 receiver supply
61 receiver transport rollers
62 control unit
64 block
66 block
68 block
70 block
72 block
74 block
76 block
78 block
80 block
82 block
84 block
86 block
88 block

1. A method of fixing marking particles to sheets in a continuous stream of receiver sheets wherein some sheets have a lighter basis weight and at least one sheet has a heavier basis weight, comprising:
a) providing two fixing members which engage each other to form a nip, at least one of the members being heated;
b) adjusting at least one parameter including temperature applied to a sheet as it passes through the nip, or speed of the sheet as it passes through the nip, or pressure in the fixing nip applied to the sheet, which will provide a predetermined gloss upon the sheet(s) after they have passed through the nip;
c) feeding the sheets of the higher basis weight media through the nip before marking particles are formed on them so that the higher basis weight sheet(s) is fed more times through the nip than the other sheet(s) and these sheets are heated in preparation for receiving marking particles; and
d) applying marking particles to the prepared heavier basis weight sheets and passing them through the nip so that the gloss formed by the marking particles is substantially the same for the heavier basis weight sheets as for the lighter basis weight sheets.

2. The method of claim 1 wherein a higher basis weight sheet is a cover sheet and the lower basis weight sheets are body sheets of a book.

3. The method of claim 1 wherein the method employs an electrophotographic duplex printer and step c) includes feeding sheets through the duplex path of the printer prior to applying marking particles to the sheets.

4. The method of claim 3 wherein the first sheet is a cover sheet and the second sheets are body sheets of a book.

5. The method of claim 4 selecting the heat applied to the sheets and the speed of the sheets as they pass through the nip.
